(19) United States
(12) Patent Application Publication
(10) Pub. No.: US 2007/0077380 A1
(43) Pub. Date: Apr. 5, 2007

(54) Coated metal components in aerosol valves and dispensing pumps for metal-sensitive compositions and process of coating the components

(76) Inventors: Geoffrey Fonseca, Suffern, NY (US); Susan E. Simpson, Wyckoff, NJ (US); Dennis Cucolo, Boynton Beach, FL (US)

Correspondence Address: Charles J. Zeller, Esq.;Avon Products Inc., Avon Place, Suffern, NY, 10901, US

(21) Appl. No.: 11/606,536

(22) Filed: Nov. 30, 2006

Related U.S. Application Data
(62) Division of application No. 10/491,354, filed on Aug. 13, 2004.
(60) Provisional application No. 60/318,801, filed on Sep. 12, 2001.

(51) Int. Cl. B32B 27/08; D02G 3/00

(52) U.S. Cl. 428/35.7; 428/371

(57) ABSTRACT

A coated component for use in a pump or valve. The coated component may be a metal spring and/or ball. Also provided is a container fitted with a pump or valve having such a coated metal spring and/or metal ball for use with a composition that includes a metal ion sensitive ingredient. The spring and/or ball exterior surface is provided with a continuous and durable coating of a polymeric material effective to reduce interaction of metal ions, the metal spring and/or ball, with the ingredient. The coating on the spring is also preferably flexible.

### BACKGROUND OF THE INVENTION

The primary function of valves and pumps is to control the dispensing of product out of the packaging container. An aerosol valve consists of an actuator assembled to a stem that presses against a metal spring or ball in the housing. The spring forces the stem against a gasket that seals a small hole in the stem. When the actuator is pressed, the spring is compressed, which brings the hole into an open position. The composition may then flow through the dip tube, the housing, spring, stem orifice, stem and actuator. A mechanical pump is much like an aerosol valve except that in a mechanical pump each actuation dispenses a certain volume of the packaged composition. In both the aerosol valve and pump, after actuation, the spring restores the component to the original closed position.

Metal components used in aerosol dispensers and non-aerosol dispensers, such as spray, lotion and other cosmetic composition pumps, are susceptible to corrosion. Corrosion of such metal components can cause small amounts of metal ions to be formed. These ions can interact with the formulation and, thus, impart a discoloration to the composition that is aesthetically unappealing to consumers. For example, it is known in the art that skin care formulations containing certain sunscreens, such as butylmethoxydibenzoylmethane (also known as avobenzone and available under the trade name Parsol 1789), are particularly sensitive to discoloration and deterioration when in the presence of metal ions. In addition, there are personal care/cosmetic compositions, such as hair sprays, fragrance sprays, mousses, insect repellants, body sprays, antiperspirant sprays and deodorant sprays as well as health care compositions and pharmaceuticals that can be corrosive to metal components, exacerbate the formation of metal ions and interact with such metal ions to cause discoloration of the composition and/or decomposition of one or more components thereof. Consumer products, e.g., household cleaning products and oven cleaners, which are dispensed in packaging having metal components, can also be benefited by the present invention. Low VOC compositions that include ingredients, such as water and/or chlorine generating compounds, are also particularly corrosive to metal components and/or result in discoloration as discussed above. Thus, over time these compositions when incorporated into spray dispensers either dispense poorly or not at all and/or become discolored. In the aerosol art attempts to resolve these problems have focused on using various coatings on the interior walls of metal aerosol containers in an effort to prevent contact of the composition with the metallic walls. To prevent metal ion/metal sensitive composition ingredient interaction, the prior art has substituted glass walled containers for metal containers. However, such containers are more expensive, fragile, and, more importantly, have not completely solved the problem.

The present inventors have determined that, surprisingly, the problem is attributable to interaction of metal ion sensitive ingredient(s) of the composition with the metal spring and/or ball employed in the valve of aerosol containers and in the pump mechanism of hand actuated pump sprayers. What is lacking in the prior art and needed is a component, especially a spring and or ball, that is resistant to both corrosion and to causing discoloration of the packaged composition. In particular, the prior art has failed to provide an aerosol valve or non-aerosol hand actuated spray pump dispenser that has coated metal spring and/or ball components and is commercially viable for use in aerosol or non-aerosol dispensing cosmetic and/or personal care packages. In point of fact, the prior art has no appreciation whatsoever of the value of coating such metal spring and/or ball components for reducing, preferably substantially preventing, more preferably preventing, interaction between metal ions arising from metal spring and/or ball valve or spray pump components with metal ion sensitive ingredient(s) of compositions stored in containers equipped with such valves or spray pumps.

### SUMMARY OF THE INVENTION

The present invention provides an improved aerosol valve and spray pump over prior art devices. In particular, the present invention provides a coated component for use in aerosol valves and spray pumps. Also provided by the present invention is a process for making such a coated component and a method for using such a coated component to prevent/reduce corrosion of the package component and/or to prevent/reduce discoloration and/or decomposition of packaged composition ingredient(s) in contact with the component. The present invention provides a coated metal spring and/or ball for aerosol valves and hand actuated spray pump useful for dispensing cosmetic/personal care compositions, and, reducing, preferably substantially preventing, more preferably preventing corrosion and product discoloration and/or product ingredient decomposition during, and thereby extending, the shelf life of the product.

### DETAILED DESCRIPTION OF THE INVENTION

The current invention relates to the use of coated components in aerosol valves and hand-actuated mechanical spray and lotion pumps to prevent corrosion of the package and/or to prevent product discoloration and/or decomposition of metal sensitive cosmetic compositions. Coated components of the present invention are resistant to ingredients in the composition and are also corrosion resistant. Since the coating of the components forms an impermeable barrier between the metal surface of the component and the composition, metal ions, which usually can form where there is a metal/composition interface, are not produced. Discoloration or degradation of the metal sensitive composition, such as compositions containing avobenzone and/or fragrances, is reduced, preferably substantially prevented, most preferably prevented. The present invention is also particularly useful for compositions that include ingredients that promulgate and or exacerbate the formation of metal ions. Particularly, compositions that include water in any amount can benefit from the present invention.

As will be elaborated upon more fully later on in this disclosure, the coated components, e.g., metal spring and/or ball, of the present invention are coated with a continuous, durable, flexible coating of a polymer.

The components of the present invention may be made of metal alloys, such as steel, stainless steel and bronze or metals, such as titanium, copper, platinum, or alloys thereof. For example, coil springs or balls useful in the present invention may be made from any of the stainless steels in the 200 series, 300 series, 400 series or equivalents thereof. The specifications and properties of each of these stainless steel products are listed by, among others, American Iron and Steel Institute (AISI), American Society for Testing and Materials (ASTM), and American National Standards Institute (ANSI). In particular, the following stainless steels are preferred: SS302, SS304, SS309 (available under the tradename NITRONICS), SS316, carbon steels and chrome steels. Preferably, the diameter or wire-size for springs of the present invention is from about 0.010 inches to about 0.050 inches and, more preferably, from about 0.020 inches to about 0.025 inches.

As is known in the art, a metal ball is sometimes used for sealing the liquid entrance in the pump or aerosol valve. In addition, the metal ball is sometimes utilized in a valve apparatus when it is desired that the package be able to dispense the composition contained therein even when the package is held in an inverted position. Such valves are known as, for example, “two-way” or “360°” valves. The ball can be any size appropriate for the dispensing mechanism. Preferably, in a package for a cosmetic or personal care composition, the ball diameter is from about 0.050 inches to about 0.200 inches, more preferably from about 0.080 inches to about 0.120 inches.

In this invention, these steel or stainless steel components are coated with a continuous, durable, flexible coating of a polymer, such as urethane, epoxy, polyamidamide (preferably, Nylon-11), epoxy-phenolic, teflon, synthetic rubber, polyethylene, polypropylene, polyvinyl chloride, silicones, silicates, or other natural or synthetic polymers (preferably, polypyrrole), including hybrid polymer materials (formed from organic and inorganic materials). Nylon-11 and polypyrrole are preferred. Nylon-11 is most preferred.
Polypyrrole has the general formula: 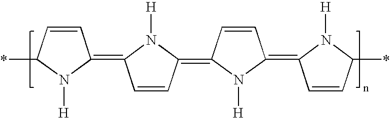
Wherein n is from 500 to 10,000.

Although, the present inventors have disclosed certain polymers that can be utilized as coating materials it should be appreciated that any polymeric material can be employed provided it produces on the exterior surface of the metal spring and/or ball a continuous, durable coating that is effective in reducing, preferably substantially preventing, most preferably preventing, interaction of metal ions of the spring and/or ball with metal ion sensitive ingredient(s) in the composition contained in the package. When the component is the metal spring the coating is also flexible in addition to continuous and durable. By continuous, durable and flexible, as used herein and in the claims that follow, the present inventors mean that the coating proves satisfactory when subjected to the durability and coverage and flexibility tests set forth below.

The following Procedures 1 and 2 detail the test methods employed to evaluate the performance of coated springs and metal components, in accordance with the present invention, with a formulation containing the metal ion sensitive ingredient.

### PROCEDURE 1

### Process for Evaluating the Durability and Coverage of Coated Metal Components

Principle:

Coated metal components are susceptible to failure in the presence of metal-sensitive formulations if the coating is not chemically resistant to the formulation or if the coating is porous and/or does not completely cover the metal component. This test method evaluates the resistance of the coated metal component to prolonged contact with cosmetic formulations and provides a basis for those in the art to evaluate the durability of the coating.

This test is carried out in conjunction with the Coating Flexibility Test detailed in Procedure 2.

Apparatus Employed:

A convection air oven maintained at about 110° F. (43° C.)

Light microscope (10× to 100× zoom magnification)

Method:

From a specified lot of components, select ten (10) samples of coated metal components to be tested. Also, select 10 (ten) uncoated metal components for test controls.

Pour the metal ion-sensitive formulation (“product”) into two suitable glass containers of appropriate size for the components. Product fill level and size of containers should allow partial immersion of the components.

Partially immerse the set of 10 coated components into the first glass container in such a manner that the components are partially in contact with the product. Partially immerse the uncoated components in the second container in a similar manner.

Cover the containers with lids in order to prevent loss of product/product ingredients during the duration of the test.

Condition the two containers at about 110° F. (43° C.). Daily, remove containers from the oven. Allow them to cool to room temperature. Examine each component, as well as the formulation in the two containers, for any change. The examination is done visually (naked eye) as well as under the microscope. Record any observable changes such as color, appearance, and condition of components, coating and the formulation.

Return samples to oven and continue test.

Re-examine components daily for a period of 8 weeks. A test duration of eight weeks at about 110° F. is generally accepted in the industry as corresponding to 2 to 3 years of shelf life at ambient temperature.

Test Criteria:

The coated samples should not show any discoloration or deterioration. Formulation in the container of the coated samples should not show any discoloration or deterioration.

Uncoated samples used as controls should show discoloration or cause deterioration to the formulation.

The coating is durable if product in contact with the coated component maintains its stability with respect to color for at least one week, more preferably four weeks, most preferably eight weeks, longer than an uncoated like component in contact with an identical product at about 110° F. More preferably, the durable coating prevents the metal sensitive composition from discoloring for at least four weeks at about 110° F. and, more preferably, for at least eight weeks at about 110° F.

### PROCEDURE 2

### Process for Evaluating the Flexibility of Coated Metal Components used in Mechanical Spray Pumps and Aerosol Valves

Principle:

The coating flex test has been developed to simulate the flexing that coated metal springs receive in service. Both the resistance of the coating to cracking and adhesion of the coating to the metal spring are evaluated.

Flexibility is used as a criterion for the measurement of coating degradation and flexural endurance of the coated spring. Experience in the use of flex testing indicates that the results obtained are of real value in estimating the life of coated metal spring in actual service.

Apparatus:

Light microscope (10× to 100× zoom magnification)

Flexing:

Flexing of the spring is done by hand or with the aid of a flexing machine that basically consists of two pistons, one is stationary, the other is capable of moving with a stroke of ¼ to ⅛ inches. The movable piston is adjustable on its shaft in order to vary the displacement stroke during the flex cycle. The spring is held between the two pistons.

Sample Size:

Select 10 coated springs.

Method:

Manual Testing:

Hold spring between the thumb and index finger.

Using a graduated scale, compress the spring to ⅛″ (if the spring is used in an aerosol valve) or ¼″ (if the spring is used in a mechanical pump). These distances correspond to actual spring compression in service when dispensing the formulation through an aerosol valve or a mechanical spray pump.

Observe the condition of the spring under the light microscope during flexing.

Check for cracks or deterioration of the coating.

Allow the spring to relax to its original position.

Repeat this compression and relaxation for a total of 40 flex cycles while examining the coated spring for any changes.

Flexing Machine:

Adjust displacement stroke of the piston to ⅛″, if the spring is used in an aerosol valve, and ¼″, if the spring is used in a mechanical spray pump.

Adjust the pistons to hold the individual spring.

Turn on the power. Test for 40 cycles.

Evaluate, using a microscope and check for cracks in or through the coating.

Test Criteria:

Satisfactory: No cracks on coating under microscopic examination.

Unsatisfactory: Any cracks to coating. Any peeling or loss of adhesion of coating.

As stated above, the valves and pumps described herein utilize the coated components (spings and/or components) of the present invention. The coating may be applied to the component in a variety of processes known in the art, such as:

Electro-deposition (also known as “Electro-coating” or “E-coating”): This process applies the coating in a way similar to electroplating. In other words, the coating is electrically deposited onto the component. In particular, an e-coat bath is prepared from the polymer resin and water (and sometimes an additional solvent). The most commonly used coating resins are urethanes, epoxies and acrylics, but the coating can be comprised of any of the polymers listed above or equivalents thereof. The electric current causes the resin particles in the bath to migrate to the surface of the component. As more and more particles collect, the coating is formed. The coating continues to be formed on all exposed metal surface areas of the component until the desired coverage of the component is attained. For the present invention, the coating is preferably uniform in thickness on the component and preferably free of any pores. The coated components are then cured in an oven at a temperature and for a time sufficient to cross-link the polymer resin into a durable coating. The e-coat process can be done on components affixed to plating racks. The components can also be coated in an electroplating barrel system.

Dip and Oven Cure

The components are dipped into a bath containing the resin and then cured in an oven. Optionally, after the components are dipped, excess resin is spun off prior to curing.

Electrostatic Coating

The coating is atomized by a sprayer into fine droplets that have a negative electrical charge. These charged droplets are repelled from one another and from the sprayer due to the electrical charge, however the charged droplets are attracted to the component, which is electrically neutral. As the coating droplets adhere to the component, they form a coating that is preferably uniform and pore free. The electrostatic coating process can also be used to deposit solid droplets on the component surface in a process called “powder coating”.

Powder Coating

In this coating process, heat is used to melt the polymer powder causing it to flow to a uniform, durable coating on the metal components. Springs are heated to about 450° F. in an oven for about 60 seconds. The heated springs are tumbled with fine dry Nylon-11 powder. On contact with the heated metal springs, the Nylon-11 melts and adheres to the metal surfaces forming a smooth, uniform and continuous coating. The coated springs are washed in water and mild detergent to remove any unfused nylon from the coated surface of the springs.

Polypyrrole Vapor Deposition

This process is done in two steps. In the first step, the metal springs are immersed for 10 minutes in an aqueous solution containing 2% hydrochloric acid in deionized water. This cleans and activates the surface of the springs. In the second step, the springs are immersed in vapors of pyrrole for 5 minutes. The pyrrole polymerizes on the spring surface to form a continuous polymer coating.

The above processes may be optimized by means known in the art to coat small objects such as the springs of the present invention. One non-limiting example of such an optimization is well known in the industry and consists of using a mesh basket to hold the springs which is possible due to the nature of the spring construction and which eliminates the need to individually rack each spring. Since the springs do not nest, the springs thereby remain separate loose parts but connected electrically by contact.

Coating

The coating thickness is in the range of about 5 to about 100 microns, preferably from about 5 to about 25 microns, more preferably from about 8 to about 12 microns, and, optimally, about 10 microns.

By coating the component with polymers, such as urethane, the component is made corrosion resistant. When the component is a spring, the coating is preferably thin and flexible enough to allow the spring to maintain its flexibility or “springiness” since the coating preferably should not affect the spring's coefficient of restitution (i.e. elasticity) even after repeated flex cycles.

Because of their chemical durability and corrosion resistance, coated components of the present invention can be used in aerosol valves and pumps for all types of cosmetic formulations, personal care compositions, pharmaceutical compositions, paints, medicaments, households products, such as cleaners, deodorizers and insect repellants, among others, where formulations are metal sensitive or corrosive to metal. With respect to personal care/cosmetic compositions, coated components of the present invention are particularly preferred when used in packaging for compositions having metal ion sensitive sunscreens, such as avobenzone, as discussed above. Compositions containing one or more of the following cosmetic ingredients that are suspected to be sensitive to metals or metal ions would benefit by being packaged in containers prepared in accordance with the present invention:

Butyl methoxydibenzoylmethane, also referred to as
avobenzone and as Parsol 1789.

Octyl salicylate
EDTA
Trisodium EDTA
Disodium EDTA
Sodium lauroyl ethylenediamine triacetate
Dihydroxyacetone
Sodium bisulfite
Sodium sulfite
Ascorbic acid
Hydrogen peroxide
Phosphoric acid
Citric acid
Aluminum chloride
Aluminum chlorohydrate

In addition to compositions containing one or more of the above listed cosmetic ingredients, insect repellant formulations containing IR 3535® (ethybutylacetylaminoproprionate), self bronzing lotions and some fragrance cologne formulations could also be advantageously packaged in accordance with the instant invention.

Furthermore, the packages of the present invention are particularly useful for compositions that have ingredients that promote/exacerbate the corrosion of the metal spring and/or metal ball and, thus, promote/exacerbate the formulation of metal ions. One such ingredient is water. As regulatory agencies are making low VOC (Volatile Organic Compound) products (i.e., products that have low quantities of Volatile Organic Compounds contained therein) increasingly mandatory, product formulations are often modified to include larger amounts of water to compensate for the decrease in VOC's. Water, which promotes metal corrosion/metal ion formation, can cause formulations to discolor and/or packages to malfunction due to the corrosion of the metal components. Accordingly, the present invention is particularly useful for such compositions/product formulations.

The present inventors evaluated numerous polymeric coating materials, utilizing Procedures 1 and 2 outlined above for determining durability, continuity and flexibility of polymeric coatings and effectiveness of same for preventing interaction of metal ion sensitive ingredient(s) with metal ions arising from metal spring and/or ball components of aerosol valves and hand actuated mechanical spray pumps. The results of such studies are set forth in Table 1 below.

In all cases the same composition was employed. The composition contained 2% avobenzone, a sunscreen sensitive to metal ions. Compositions containing avobenzone are known to discolor when interacted with metal ions. Each coated spring was immersed in the avobenzone containing composition and stored for one week at a temperature of about 110° F. At the end of the one week storage period, observations were made on each spring/composition tested.

Table 1 shows the coating process (the details of which are provided earlier in this disclosure) and the polymer employed in each case.

TABLE 1

| Coating Process | Coating Polymer | |
|---|---|---|
| Employed | Employed | Results |
| Dip and Oven Cure | CLEARKLAD ® | Red discoloration in product; Coating |
| | (Xontal Ltd.) | softened. |
| Dip and Oven Cure | TUFF COTE ® (Gemite | Red discoloration in product |
| | Products Inc.) | |
| Dip and Oven Cure | HARP1 ® (Xontal Ltd.) | Red discoloration in product |
| Dip and Oven Cure | NEWRANE ® BC0712 | Red discoloration |
| | (Newchem Corporation) | |
| Dip and Oven Cure | EPOXY EITC ® (#3) and | Red discoloration |
| | Epoxy 1124 (#4) (Technical | |
| | Coatings, Inc.) | |
| Dip and Oven Cure | AGATE ® epoxy lacquer | Red discoloration |
| | WB-19-327 (Agate Lacquer | |
| | Mfg Co., Inc.) | |
| Dip and Oven Cure | CIC ® (Quest Coatings Inc.) | Coating softened; Red discoloration |
| Dip and Oven Cure | EGG ® (Quest Coatings Inc.) | Coating softened; Light brown discoloration |
| Electrodeposition | CLEARLYTE ® | Coating softened; Red discoloration |
| | (Enthone-OMI Inc.) | |
| Electrodeposition | SUPERHARP ® | Red discoloration |
| | (Xontal Ltd.) | |
| Electrodeposition | ACR 41 Gold strike RTU ® | Red discoloration |
| | (Technic Inc.) | |
| Electrodeposition | ACID GOLD STRIKE ® | Red discoloration |
| | (Technic Inc.) | |
| Electrodeposition | CHROMATE HARP 35 | Red discoloration |
| | THERMAL HARDCOATt ® | |
| | (Xontal Ltd.) | |
| Electrodeposition | CHROMATE HARP 35 ® | Red discoloration |
| | (Xontal Ltd.) | |
| Polypyrrole Vapor Deposition | Polypyrrole | No discoloration at 1 week. Storage |
| | | continued at 110° F. for 3 more weeks at which |
| | | time slight discoloration was observed. Four |
| | | weeks at 110° F. projects to a shelf stability of |
| | | 1 to 1½ years. |
| Powder Coating | Nylon 11 | No discoloration after 1 week at 110° F. |
| | | Storage continued to 6 weeks - no |
| | | discoloration evident. This translates to 2 |
| | | years shelf storage. All indications are that at |
| | | least 8 weeks storage at 110° F. will produce |
| | | no discoloration. This is indicative of a |
| | | projected shelf stability of at least 3 years. |

It is evident from the result of Table 1 above that not all polymers when coated on the metal spring and/or metal ball prevent interaction of metal ions from the spring and/or ball that is in contact with one or more metal ion sensitive ingredients for a sufficient period of time to enable the production of a product having shelf storage stability, much less, a product having long term shelf storage stability.

It should be noted that a product that has shelf storage stability, as used herein, means a product that can be stored at about 110° F. for four weeks and will at such time exhibit very slight discoloration. Most desirably the polymer coated metal spring and/or ball when contacted with a composition containing a metal ion sensitive ingredient and stored at about 110° F. exhibits very little or no discoloration (indicative of interaction of metal ions with the metal ion sensitive ingredient), for a period of at least eight weeks; such products are herein referred to as products having long term shelf storage stability. Shelf-storage stability according to the present invention, which is an improvement on the prior art container, may also be demonstrated by comparing the length of storage stability, with respect decreased or no discoloration, for a product that has been packaged in a container of the present invention as compared to an identical product that has been packaged in a prior art container. The purview of the present invention includes compositions in containers that have a coated metal ball and/or spring that demonstrate little or no visible discoloration for at least one week at about 110° F. as compared to an identical composition in a like container where the exterior of the metal ball and/or metal spring is not coated.

Clearly polypyrrole coated springs and/or balls in accordance with the present invention enable the production of products having shelf storage stability. Nylon-11, the preferred polymer coating material, enables the production of products that have long term shelf storage stability.

Although the invention has been described with respect to the preferred polymer coating for the spring, it should be understood that, with respect to the spring, the coating can be of any material that (a) is substantially flexible and resilient enough to comply with the movement of the spring without compromising the structural integrity of the coating, and (b) is effective to prevent creation of metal ions due to the reaction between the metal spring and the composition in the container. The polymer coating used for other metal components or surfaces of the container, such as the ball, may not require the same attention to flexibility and resiliency, as long as the polymer coating is effective to prevent migration of metal ions from the metal container into the composition contained therein, as discussed above.

As can be appreciated by those skilled in the art, various modifications and alterations to the present invention may be appreciated based on a review of the foregoing description, and any and all such changes and additions are intended to be within the scope and the spirit of the present invention.

What is claimed is:

1. A metal spring for a pump or valve, said spring having its exterior surface coated with a continuous, durable and flexible coating of a polymeric material, said coating being effective to reduce interaction of metal ions of the spring with a metal ion sensitive material in contact therewith.

2. The metal spring as claimed in claim 1, wherein said coating enables contact of the spring with said metal ion sensitive material for four weeks at about 110° F. with slight discoloration indicative of interaction of metal ions of the spring with the metal ion sensitive material.

3. The metal spring as claimed in claim 1, wherein said coating enables contact of the spring with said metal ion sensitive material for eight weeks at about 110° F. with slight discoloration indicative of interaction of metal ions oaf the spring with the metal ion sensitive material.

4. The metal spring as claimed in claim 1, wherein said coating enables contact of the ball with said metal ion sensitive material for four weeks at about 110° F. with slight discoloration indicative of interaction of metal ions oaf the spring with the metal ion sensitive material.

5. The metal spring as claimed in claim 1, wherein said coating enables contact of the ball with said metal ion sensitive material for eight weeks at about 110° F. with slight discoloration indicative of interaction of metal ions oaf the spring with the metal ion sensitive material.

6. A metal ball for a pump or valve, said ball having its exterior surface coated with a continuous and durable coating of a polymeric material, said coating being effective to reduce interaction of metal ions of the ball with a metal ion sensitive material in contact therewith.

7. The metal ball as claimed in claim 6, wherein said coating enables contact of the ball with said metal ion sensitive material for four weeks at about 110° F. with slight discoloration indicative of interaction of metal ions of the ball with the metal ion sensitive material.

8. The metal ball as claimed in claim 6, wherein said coating enables contact of the ball with said metal ion sensitive material for eight weeks at about 110° F. with slight discoloration indicative of interaction of metal ions of the ball with the metal ion sensitive material.

9. The metal ball as claimed in claim 6, wherein said coating enables contact of the ball with said metal ion sensitive material for four weeks at about 110° F. with slight discoloration indicative of interaction of metal ions of the ball with the metal ion sensitive material.

10. The metal ball as claimed in claim 6, wherein said coating enables contact of the ball with said metal ion sensitive material for eight weeks at about 110° F. with slight discoloration indicative of interaction of metal ions of the ball with the metal ion sensitive material.
